(19) United States
(12) Patent Application Publication
(10) Pub. No.: US 2009/0134864 A1
(43) Pub. Date: May 28, 2009

(54) Inductive Sensor

(76) Inventors: Siegfried Hofler, Hannover (DE); Gunther Singbartl, Hannover (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/225,962

(22) PCT Filed: Apr. 28, 2007
(86) PCT No.: PCT/EP2007/003797

§ 371 Date: Oct. 1, 2008

(30) Foreign Application Priority Data
May 5, 2006 (DE) 10 2006 021 018.2

(51) Int. Cl. G01P 3/48; G01P 1/02

(52) U.S. Cl. 324/173

(57) ABSTRACT

The invention relates to an inductive sensor with an electrical coil assembly (1, 2,3) which has a coil body (2) and a wire wound coil (1), wherein at least one wire end (6, 7) is guided out of the wire wound coil (1) to electrical connection elements (17, 18) which connect the coil assembly (1, 2, 3) to the surrounding area, wherein the coil assembly (1, 2, 3) is at least partly extrusion-coated by an extrusion-coat mass (12) and is located in a pot-shaped housing (13). Therefore, an improved inductive sensor with regard to temperature change stability is specified. Said inductive sensor has at least one barrier (10, 11, 100) near the wire ends (6, 7) which are guided out of the wire wound coil (1) and is located between the wire ends (6, 7) which are guided out of the wire wound coil (1) and the injection point of the extrusion-coat mass (12) during the extrusion-coating. The extrusion-coat mass (12) is laterally deflected from the area within which the wire ends run and basically flows at a right angle to the wire ends, wherein the partial streams meet near the wire ends.

The present invention relates to an inductive sensor having an electric coil subassembly according to the preamble of claim 1.

Inductive sensors are used, for example, for sensing speeds of revolution of vehicle wheels, possibly, in order to generate input signals for vehicle anti-lock braking systems. A known sensor for sensing speeds of revolution is described in, for example, EP 0 384 014 B1.

In sensors of the general type under consideration, the coil wire usually must be routed to two electric terminals, which are formed from sheet metal strips, for example, in order to achieve sufficient mechanical stability. To take advantage of available installation space, the coil wire itself is made from relatively thin wire, which is therefore susceptible to breakage. In such sensors, therefore, the coil subassembly is coated at least partly with an injection-molding compound in order to increase its mechanical stability. The area of the wire ends extending out of the coil winding to the terminals is usually also coated in the same operation. Because of different thermal expansion coefficients of the wire material, such as copper, and of the injection-molding compound, stresses and strains between the wire and the compound can develop during temperature fluctuations, and in the case of extremely frequent temperature fluctuations, may lead to damage to the wire ends led out of the coil winding to the terminals.

The object of the present invention is therefore to provide an improved inductive sensor with respect to thermal fatigue resistance.

This object is achieved by the embodiment of the present invention specified in claim 1. Improvements and advantageous configurations of the invention are specified in the additional claims.

By means of the present invention, the thermal fatigue resistance of an inductive sensor can be improved considerably in a simple and cost-effective manner, specifically, by providing a barrier for the injection-molding compound. Experiments have shown that the number of temperature-change cycles can be increased immediately by a factor of five by the present invention.

The barrier is disposed between the wire end guided out of the coil winding and the point of injection of the injection-molding compound during the injection-molding operation, so that the injection-molding compound does not encounter the wire end directly during the injection-molding operation, but, rather, is first diverted by the barrier and, after having passed the barrier, encounters the wire end in a different flow direction than in the case of a sensor without a barrier. According to advantageous embodiments of the present invention, once the injection-molding compound has solidified in the region of the wire end extending out of the coil winding, or in other words after it has passed the barrier, it has lower density than in the other regions provided with compound. According to a further advantageous embodiment, the molecular orientation of the injection-molding compound that has solidified in the region of the wire end led out of the coil winding runs predominantly perpendicular to the wire end. Experiments have shown that the materials usually used as injection-molding compounds have a smaller thermal expansion coefficient in the direction of their molecular orientation than in other directions. Thus, the perturbing influence of the thermal expansion coefficient of the injection-molding compound can be largely compensated for by the deflection of the compound by means of the barrier.

The present invention will be explained in detail hereinafter and further advantages will be pointed out on the basis of the accompanying drawings, wherein:

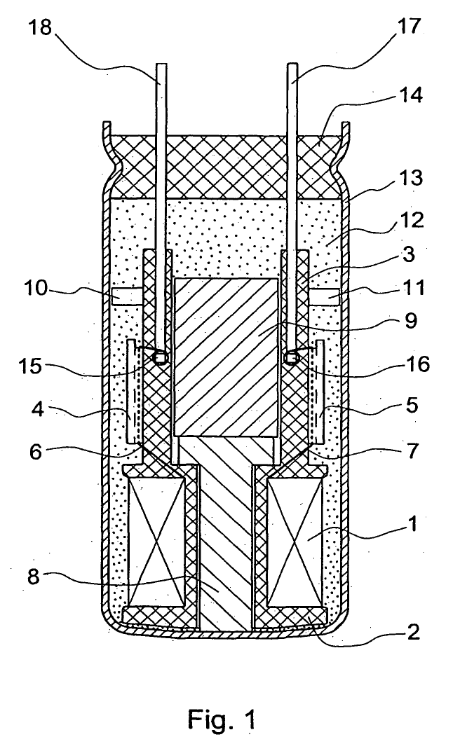

FIG. 1 shows an embodiment of the inventive sensor in longitudinal section, and

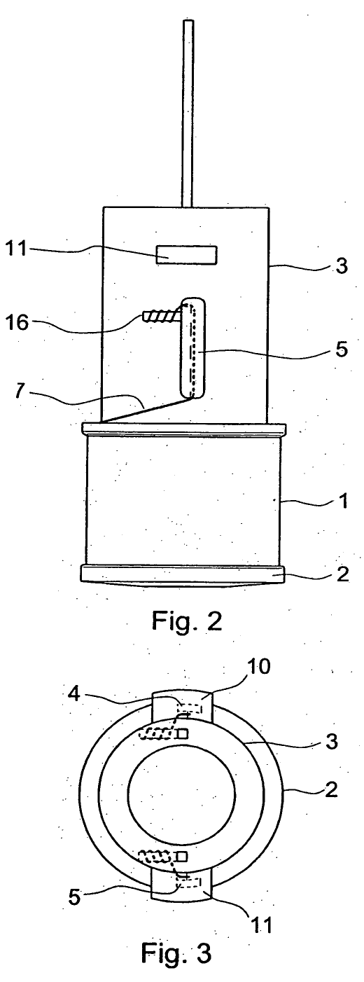

FIG. 2 shows an electric coil subassembly in side view, and

FIG. 3 shows the coil subassembly according to FIG. 2 in an overhead view, and

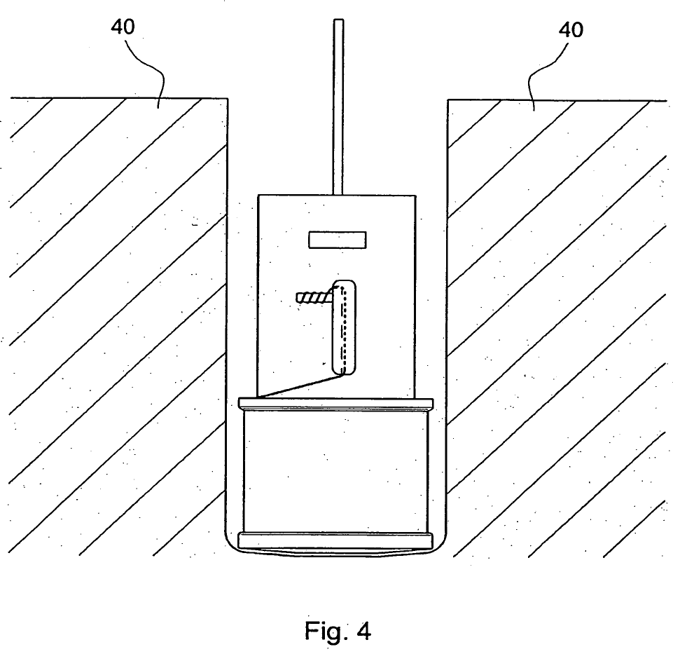

FIGS. 4 to 6 show various steps during manufacture of the inventive sensor, and

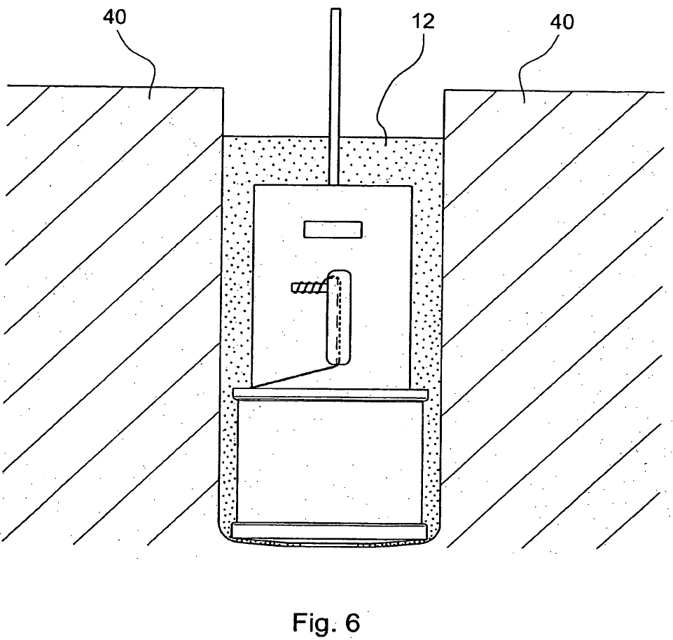

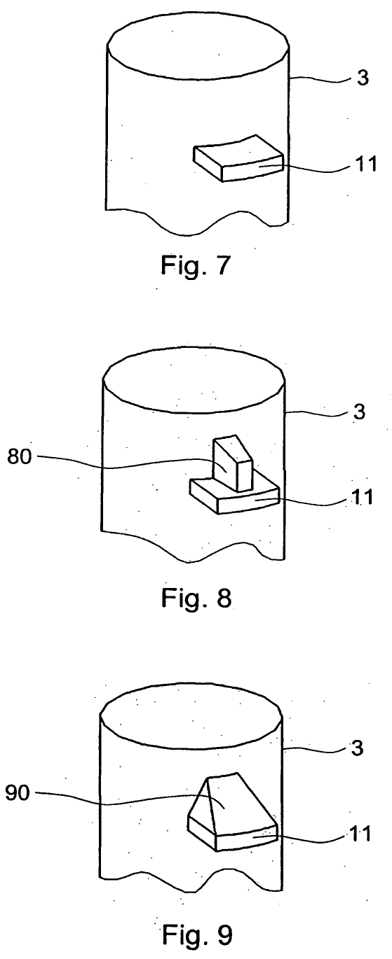

FIGS. 7 to 9 show further embodiments of the barrier, and

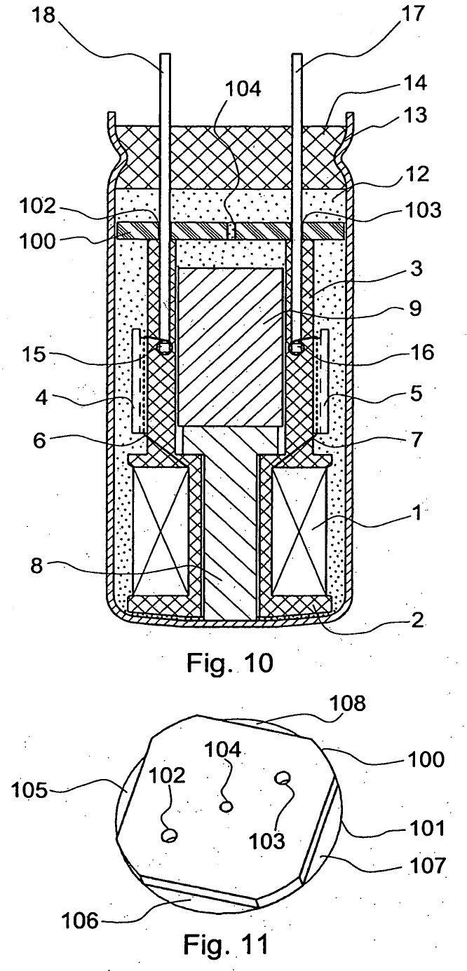

FIG. 10 shows a further embodiment of the inventive sensor, and

FIG. 11 shows a plate-shaped barrier, and

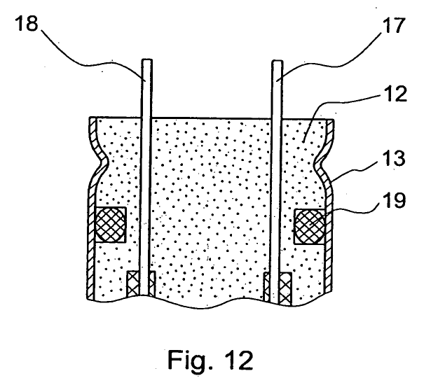

FIG. 12 shows a still further embodiment of the inventive sensor.

In the figures, like reference numerals are used for corresponding parts.

FIG. 1 depicts a first embodiment of the inventive sensor as a longitudinal section. The sensor is provided with an electric coil subassembly (1, 2, 3) including a coil former (2) on which there is wound an electric coil winding (1) of wire. A first and a second wire end (6, 7) extend from coil winding (1) to electric terminal points (15, 16) and are electrically connected to these terminal points, for example by soldering or welding. Terminal points (15, 16) are electrically connected to terminal elements (17, 18) or are formed in one piece therewith. Terminal elements (17, 18) are used for connecting the sensor electrically to an electronic evaluating unit, such as the control unit of a vehicle anti-lock braking system. As an example, terminal elements (17, 18) are made of sheet-metal strips or square wire.

Electric terminal points (15, 16) are disposed in a region (3) of coil former (2) that extends beyond coil winding (1) in longitudinal direction of coil subassembly (1, 2, 3). In this region (3) there are also located guide elements (4, 5), which are used for fastening and guiding the wire end out of coil winding (1). Guide elements (4, 5) are preferably provided with a tangentially open guide contour for receiving the wire end. The guide contour can be formed, for example, as a lateral longitudinal slit in guide element (4, 5); so, guide elements (4, 5) can have a substantially L-shaped cross section.

A permanent magnet (9) as well as a shouldered pole pin (8) of material having good magnetic conductivity are disposed inside coil subassembly (1, 2, 3). In the embodiment according to FIG. 1, pole pin (8) is disposed with its narrow end in the region surrounded by coil winding (1). The other regions of pole pin (8) as well as permanent magnet (9) are disposed outside the region surrounded by coil winding (1). By virtue of this arrangement, high efficiency or, in other words, high sensitivity of the sensor is achieved. However, the present invention is not restricted to this type of arrangement of permanent magnet and pole pin, and can also be used advantageously with other arrangements.

During manufacture of the sensor, its structural elements described above are coated with an injection-molding compound (12) in an injection-coating die described in greater detail hereinafter. A thermoplastic, especially a polyamide material, can be used as the injection-molding compound. The coated components are better protected against mechanical damage and moisture than they would be without the coating. A further increase of mechanical strength can be achieved by using compounds that are reinforced with glass beads and/or with glass fibers. A further substantial increase in mechanical stability is possible in particular by means of reinforcement with glass fibers. The injection-molding coating has the further advantage that the pole pin (8) as well as the permanent magnet (9) are fixed thereby.

The coated components are disposed in a pot-like housing (13). As an example, housing (13) can be formed as a deep-drawn metal part. Housing (13) is encapsulated in moisture-proof manner by an encapsulating piece (14), which is pressed interlockingly into housing (13), and which is open at only one end. According to an alternative configuration, instead of a separate encapsulating piece (14), the space provided therefor is filled substantially with injection-molding compound (12) and a ring-shaped seal (19) between the compound and housing (13) is provided for sealing, as illustrated by the partial section in FIG. 12. In order to form the annular space for receiving seal (19) in compound (12), a complementary contour is provided in the die to be used for the injection-molding operation.

Barriers (10, 11) are provided in region (3) of the coil former, and are disposed between wire end (6, 7) led out of coil winding (1) and the point of injection of compound (12) during the injection-molding operation. The arrangement and principle of action of barriers (10, 11) is discussed in greater detail hereinafter.

FIG. 2 shows coil subassembly (1, 2, 3) before the injection-molding operation has been performed but after coil winding (1) has been mounted. Compared with the sectional diagram of FIG. 1, coil subassembly (1, 2, 3) is illustrated in a view turned by one quarter of a revolution around the longitudinal axis, so that barriers (11) as well as guide element (5) are visible in overhead view. The further barrier (10) as well as the further guide element (4) are located on the back side of region (3) and for this reason are not visible in FIG. 2.

FIG. 3 shows coil subassembly (1, 2, 3) according to FIG. 2 in an overhead view in the direction of region (3) of coil former (2). In this view, barriers (10, 11) conceal guide elements (4, 5), which for this reason are indicated by broken lines. As is evident, however, wire ends (6, 7) are guided in respective longitudinal slits of guide elements (4, 5). Also evident is the substantially L-shaped cross section of guide elements (4, 5).

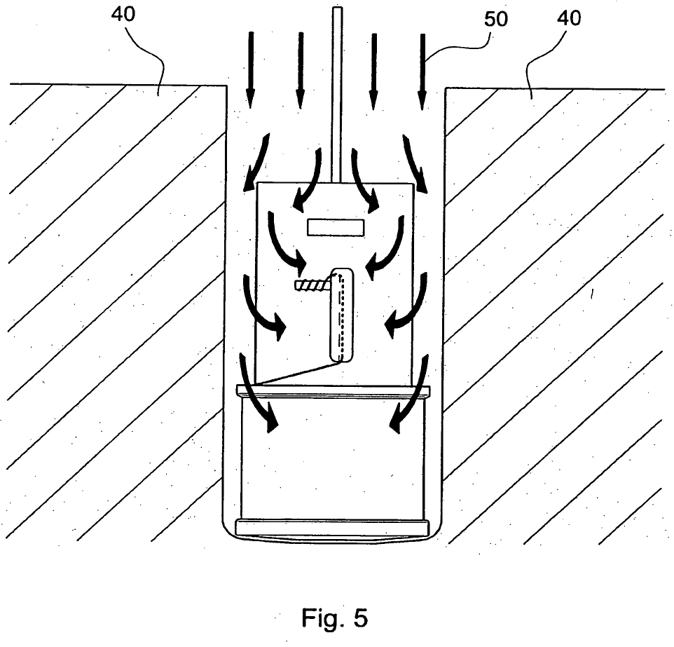

FIG. 4 illustrates coil subassembly (1, 2, 3) according to FIG. 2 after it has been introduced into an injection-molding die (40). Pole pin (8) as well as permanent magnet (9) are already located in the interior of coil former (2). Die (40) is provided with a receiving opening for coil subassembly (1, 2, 3), the inside dimensions of this opening being matched to the inside dimensions of housing (13). FIG. 5 illustrates the beginning of the injection-molding operation. The liquid injection-molding compound is symbolized by arrows (50), which represent the flow direction of the compound. As is evident, barriers (10, 11) cause deflection of the flow direction of the compound, initially away from wire ends (6, 7) located behind barriers (10, 11). Behind the respective barriers, the injection-molding compound then flows in substantially perpendicular direction toward wire end (6, 7), which is routed along guide element (4, 5). The two streams of compound formed because of barriers (10, 11), at the left and right thereof, then meet one another in the region of wire end (6, 7) routed along guide element (4, 5). As a result, a lower density of the compound in the region of terminal points (15, 16) and of wire ends (6, 7) routed outside coil winding (1) can be achieved. In these regions, moreover, the molecular orientation of the injection-molding compound after solidification is predominantly perpendicular to wire ends (6, 7).

FIG. 6 shows the finished subassembly with cured compound (12). This subassembly can now be removed from die (40) and disposed in housing (13).

In FIGS. 7 to 9, region (3) of coil former (2) is illustrated respectively in perspective partial sections. FIG. 7 shows a first embodiment of barrier (11), as was already illustrated for the sensor according to FIG. 1. The embodiment of barrier (11) according to FIG. 7 is provided with a substantially rectangular cross section having a rounded end at the outer end of barrier (11). The radius of the rounded end is preferably matched to the inside radius of housing (13).

FIG. 8 shows a second embodiment of barrier (11), which compared with the embodiment according to FIG. 7 is expanded by a rib (80) oriented in longitudinal direction of coil subassembly (1, 2, 3). Rib (80) provides reinforcement of barrier (11). Furthermore, rib (80) favorably influences the course of the flow of the injection-molding compound during the injection-molding operation, to the effect that further improvement of the thermal fatigue resistance of the sensor can be achieved.

The embodiment of barrier (I 1) according to FIG. 9 is provided with a guide contour (90) that has radial and tangential ramps and is disposed on the side facing away from coil winding (1). Guide contour (90) produces a further improvement of the course of the flow of the injection-molding compound and, as a result, a further improvement of the thermal fatigue resistance of the sensor.

It should be understood that the foregoing discussion is applicable to the other barrier (10) also.

FIG. 10 illustrates a second embodiment of the inventive sensor in longitudinal section. In contrast to the embodiment according to FIG. 1, a plate-like barrier (100) is provided according to FIG. 10, instead of barriers (10, 11). As illustrated in FIG. 10, plate-like barrier (100) may be formed as a separate component, which is disposed above region (3) of coil former (2). However, barrier (100) may also be formed in one piece with coil former (2). FIG. 11 shows plate-like barrier (100) in a perspective view. FIG. 11 shows an embodiment of barrier (100) as a substantially square plate with rounded corners, wherein the corner radii are matched to the inside radius of housing (13). The inside radius of housing (13) is indicated in FIG. 11 by line (101). Barrier (100) is provided with openings (102, 103) through which terminal elements (17, 18) can be led. Also provided is a passage opening (104), through which the injection-molding compound can reach permanent magnet (9) and pole pin (8) during the injection-molding operation.

During the injection-molding operation using barrier (100), the injection-molding compound flows past the outside thereof, specifically through openings (105, 106, 107, 108) between barrier (100) and die (40), these openings having the shape of segments of a circle because of the square outside contour of barrier (100). Moreover, the injection-molding compound flows through passage opening (104) to permanent magnet (9) and pole pin (8) and fixes them.

1. An inductive sensor having an electric coil subassembly (1, 2, 3), including a coil former (2) and a coil winding (1) of wire, wherein at least one wire end (6, 7) is led out of the coil winding (1) to electric terminal elements (17, 18), which are used for connecting the coil subassembly (1, 2, 3) to the surroundings, the coil subassembly (1, 2, 3) being at least partly coated with an injection-molding compound (12) and being disposed in a pot-like housing (13), characterized in that there is provided, in the region of the wire end (6, 7) led out of the coil winding (1), at least one barrier (10, 11, 100), which is disposed between the wire end (6, 7) led out of the coil winding (1) and the point of injection of the compound (12) during the injection-molding operation.

2. A sensor according to claim 1, characterized in that, once the compound (12) has solidified in the region of the wire end (6, 7) led out of the coil winding (1), it has lower density than is the case in the other regions provided with the compound (12).

3. A sensor according to at least one of the preceding claims, characterized in that the molecular orientation of the compound (12) that has solidified in the region of the wire end (6, 7) led out of the coil winding (1) runs predominantly perpendicular to the wire end.

4. A sensor according to at least one of the preceding claims, characterized in that the pot-like housing (13) is made of metal.

5. A sensor according to at least one of the preceding claims, characterized in that the coil subassembly (1, 2, 3) is completely coated with the compound (12).

6. A sensor according to at least one of the preceding claims, characterized in that the compound (12) is reinforced with glass beads.

7. A sensor according to at least one of the preceding claims, characterized in that the compound (12) is reinforced with glass fibers.

8. A sensor according to claim 7, characterized in that, after the compound (12) has solidified in the region of the wire end (6, 7) led out of the coil winding (1), the fiber direction thereof is predominantly perpendicular to the wire end.

9. A sensor according to at least one of the preceding claims, characterized in that each terminal element (17, 18) has a respective terminal point (15, 16) for connection of the wire end, which point is disposed between the barrier (10, 11, 100) and the coil winding (1) relative to the longitudinal extent of the coil subassembly (1, 2, 3).

10. A sensor according to claim 9, characterized in that, after the compound (12) has solidified in the region of the terminal point (15, 16), it has lower density than in the other regions provided with the compound (12).

11. A sensor according to at least one of claims 9 to 10, characterized in that, after the compound (12) has solidified in the region of the wire end (6, 7) led out of the coil winding (1), the molecular orientation thereof is predominantly perpendicular to the area in which the terminal point (15, 16) extends.

12. A sensor according to at least one of claims 9 to 11, characterized in that, after the compound (12) has solidified in the region of the terminal point (15, 16), the fiber direction thereof is predominantly perpendicular to the area in which the terminal point extends.

13. A sensor according to at least one of the preceding claims, characterized in that the barrier (10, 11, 100) deflects the flow direction of the injection-molding compound approximately at right angles after it has passed the barrier during the injection-molding operation.

14. A sensor according to at least one of the preceding claims, characterized in that the barrier (10, 11, 100) extends in radial direction at least approximately to the outside surface of the injection-molding compound (12).

15. A sensor according to at least one of the preceding claims, characterized in that the barrier (10, 11, 100) is provided with a least one ramp-like guide contour (90) for guiding the injection-molding compound during the injection-molding operation.

16. A sensor according to at least one of the preceding claims, characterized in that the coil former (2) extends beyond the coil winding (1) in longitudinal direction of the coil subassembly (1, 2, 3) and the barrier (10, 11, 100) is disposed in the region (3) extending therebeyond.

17. A sensor according to claim 16, characterized in that the wire end (6, 7) led out of the coil winding (1) is routed along the region (3) of the coil former (2) that extends beyond the coil winding (1).

18. A sensor according to at least one of claims 16 to 17, characterized in that at least one guide element (4, 5) for guiding the wire end (6, 7) is disposed on the region (3) of the coil former (2) that extends beyond the coil winding (1).

19. A sensor according to claim 18, characterized in that the guide element (4, 5) is provided with a tangentially open guide contour for receiving the wire end (6, 7).

20. A sensor according to at least one of the preceding claims, characterized in that the barrier (100) is formed as a plate-like component.

21. A sensor according to at least one of the preceding claims, characterized in that a thermoplastic, especially polyamide, is used as the injection-molding compound (12).
